(19) United States
(12) Patent Application Publication
(10) Pub. No.: US 2024/0320508 A1
(43) Pub. Date: Sep. 26, 2024

(54) TRANSFER LEARNING FOR METROLOGY DATA ANALYSIS

(71) Applicant: Onto Innovation Inc., Wilmington, MA (US)

(72) Inventors: Jie Li, San Jose, CA (US); Petar Zuvela, Singapore (SG); Jonathan Andrew Miller, Fremont, CA (US)

(73) Assignee: Onto Innovation Inc., Wilmington, MA (US)

(21) Appl. No.: 18/611,195

(22) Filed: Mar. 20, 2024

Related U.S. Application Data
(60) Provisional application No. 63/491,700, filed on Mar. 22, 2023.

(51) Int. Cl. G06N 3/096; G06N 3/045

(52) U.S. Cl. CPC G06N 3/096; G06N 3/045

(57) ABSTRACT

Non-contact measurements, such as optical measurements or X-ray measurements, of a structure are supported using transfer learning for training a machine learning (ML) model for predicting key parameters. A first set of metrology data for a first set of structures is obtained and used to train a first ML model. A second set of metrology data for a second one or more structures is obtained. Transfer learning from the first ML model to the second set of metrology data is performed to produce a second ML model for predicting key parameters of the second one or more structures. Domain adaptation may be used in which metrology data is selected from the first set of metrology data and the second set of metrology data using a feature extractor and used to train a ML model for predicting key parameters of the second one or more structures.

### CROSS REFERENCE TO RELATED APPLICATIONS

This application claims priority under 35 U.S.C. § 119 to U.S. Provisional Application No. 63/491,700, filed Mar. 22, 2023, entitled “TRANSFER LEARNING FOR METROLOGY DATA ANALYSIS,” which is assigned to the assignee hereof and is incorporated herein by reference in its entirety.

### FIELD OF THE DISCLOSURE

Implementations of the subject matter described herein are related generally to metrology, and more particularly to modeling metrology data.

### BACKGROUND

Semiconductor and other similar industries often use metrology equipment, such as optical metrology equipment, to provide non-contact evaluation of samples during processing. With optical metrology, a sample under test is illuminated with light, e.g., at a single wavelength or multiple wavelengths. After interacting with the sample, the resulting light is detected and analyzed to determine one or more characteristics of the sample.

The analysis typically includes a model of the structure under test. The model may be generated based on the materials and the nominal parameters of the structure, e.g., film thicknesses, line and space widths, etc. One or more parameters of the model may be varied, and the predicted data may be calculated for each parameter variation based on the model, e.g., using Rigorous Coupled Wave Analysis (RCWA) or other similar techniques. The measured data may be compared to the predicted data for each parameter variation, e.g., in a nonlinear regression process, until a good fit is achieved between the predicted data and the measured data, at which time the fitted parameters are determined to be an accurate representation of the parameters of the structure under test.

Metrology techniques, including data analysis and recipes, perform well under certain assumptions, such as the data (spectra and reference) used to optimize the recipes and the test data from inline measurements are drawn from the same distribution. When the distribution changes, e.g., when substrate processing changes, the accuracy of the data analysis and/or recipes typically degrades. Therefore, what is needed is an improved process that can be used to increase the robustness of the metrology techniques.

### SUMMARY

Non-contact measurements, such as optical measurements or X-ray measurements, of a structure are supported using transfer learning for training a machine learning (ML) model for predicting key parameters. A first set of metrology data for one or more structures is obtained and used to train a first ML model. A second set of metrology data for a second one or more structures is obtained. Transfer learning from the first ML model to the second set of metrology data is performed to produce a second ML model for predicting key parameters of the second one or more structures. Transfer learning through domain adaptation may be used in another implementation in which metrology data is selected from the first set of metrology data and the second set of metrology data using a feature extractor and used to train a ML model for predicting key parameters of the second one or more structures.

In one implementation, a method for supporting measurement of structures includes obtaining a first set of metrology data for a first one or more structures and training a first machine learning model for the first one or more structures using the first set of metrology data. A second set of metrology data for a second one or more structures is obtained. Transfer learning from the first machine learning model to the second set of metrology data is performed to produce a second machine learning model for predicting key parameters for the second one or more structures.

In one implementation, a computer system configured for supporting measurement of structures includes at least one processor that is configured to obtain a first set of metrology data for a first one or more structures and train a first machine learning model for the first one or more structures using the first set of metrology data. The at least one processor is further configured to obtain a second set of metrology data for a second one or more structures. The at least one processor is further configured to perform transfer learning from the first machine learning model to the second set of metrology data to produce a second machine learning model for predicting key parameters for the second one or more structures.

In one implementation, a method for supporting measurement of structures includes obtaining a first set of metrology data for a first one or more structures and obtaining a second set of metrology data for a second one or more structures. Metrology data from the first set of metrology data and the second set of metrology data is selected using a feature extractor. Using the selected metrology data, a machine learning model is trained for predicting key parameters for the second one or more structures.

In one implementation, a computer system configured for supporting measurement of a structure includes at least one processor that is configured to obtain a first set of metrology data for a first one or more structures and obtain a second set of metrology data for a second one or more structures. The at least one processor is further configured to select metrology data from the first set of metrology data and the second set of metrology data using a feature extractor. The at least one processor is further configured to train a machine learning model with selected metrology data for predicting key parameters for the second one or more structures.

### BRIEF DESCRIPTION OF THE DRAWINGS

FIG. 1 illustrates a schematic view of a metrology device that may be configured to support optical measurement of one or more structures as discussed herein.

FIG. 2A illustrates a general workflow used in conventional modeling and library generation.

FIG. 2B illustrates a workflow illustrating one implementation of modeling and predicting key parameters, as described herein.

FIG. 2C illustrates a workflow showing a generalized implementation of modeling and predicting key parameters, as described herein.

FIG. 3 illustrates an example of a transfer learning process for metrology data.

FIG. 4 illustrates an example of a source domain and target domain in the form of spectra.

FIG. 5 illustrates an example of a transfer learning with domain adaptation process for metrology data.

FIG. 6 shows an illustrative flowchart depicting an example operation for supporting measurement of structures, according to some implementations.

FIG. 7 shows an illustrative flowchart depicting an example operation for supporting measurement of structures, according to some implementations.

### DETAILED DESCRIPTION

During fabrication of semiconductor devices and similar devices it is very often necessary to monitor the fabrication process by non-destructively measuring the devices. Optical metrology and X-ray metrology are examples of non-contact metrology techniques that may be employed for non-contact evaluation of samples during processing. For example, optical metrology techniques, such as thin film metrology and Optical Critical Dimension (OCD) metrology, may use modeling of the structure to generate predicted data that is to be compared with the measured data from the sample. Variable parameters in the model, such as layer thicknesses, line widths, space widths, sidewall angles, material properties, etc., may be varied and the predicted data is generated for each variation. The measured data from a sample under test may be compared with the predicted data for each parameter variation, e.g., in a nonlinear regression process, until a good fit is achieved, at which time the values of the fitted parameters are determined to be an accurate representation of the parameters of the sample.

Modeling typically uses physics-based techniques such as Rigorous Coupled Wave Analysis (RCWA), Finite-Difference Time-Domain (FDTD) or Finite Element Method (FEM), which require detailed knowledge of the structure. For example, modeling requires that preliminary structural and material information is known about the sample in order to generate an accurate representative model of the sample, which may include one or more variable parameters. The preliminary structural and material information for a sample may include the type of structure and a physical description of the sample with nominal values for various parameters, such as layer thicknesses, line widths, space widths, sidewall angles, etc., along with a range within which these parameters may vary. The sample may further include one or more sample parameters that are not variable, i.e., are not expected to change in a significant amount during manufacturing.

Traditional modeling for metrology has high level of fidelity to the physical constraints of the sample (as well as the metrology device parameters). A library may be pre-generated to increase measurement throughput. However, building an accurate library has a slow time-to-solution (TTS) and high computation cost, particularly for complex structures, such as 3D-NAND devices. For example, typical TTS for library generation may range from multiple days up to weeks and may employ tens of computational nodes (blades). Moreover, accuracy of a pre-generated library may be impaired for complex structures with a large misfit, i.e., it is difficult to achieve a good correlation to a reference sample. Further, the recipe robustness suffers from model assumptions, such as fixed and coupled parameters. Accordingly, generation of an accurate library may require spectra for a large number of model variants, e.g., hundreds to thousands of model variants, further, a post library optimization process may be used, which further increases TTS and computational power requirements.

Other measurement techniques are available, such as machine learning (ML), which provide a significantly faster TTS with reduced computational power requirements. However, ML typically requires a large amount of reference data, which is costly to acquire, or the recipe robustness will be compromised.

The data analysis techniques for metrology assumes that the reference data, e.g., the reference spectra and reference parameters, used for building libraries or ML training, are from the same distribution as the measured data from the sample under test. If the distribution changes, e.g., the process used to generate the sample from which the measured data is obtained differs from the process assumptions used for the reference data, then the accuracy of the recipes, and thus, the data analysis, will degrade. Consequently, the lifetime of a library or ML training may be limited due to process variations, and new library generation and/or ML training may be required.

As discussed herein, a transfer learning approach is used to improve recipe generation for non-contact metrology, such as optical metrology. It should be understood that while various aspects of the present disclosure are described with reference to “optical metrology” and “optical metrology data,” the present disclosure may be applied to other types of non-contact metrology, including X-ray metrology and other metrology techniques that use radiation of one form or another to produce metrology data, and thus, the present disclosure is not limited to optical metrology unless specifically stated.

For example, a first set of metrology data may be obtained for one or more structures and a first machine learning model trained for the one or more structures using the first set of metrology data. The first set of metrology data may be synthetic data generated from physical models or may be experimental data measured from one or more reference structures or combination of both. The first set of metrology data, for example, may cover a wider process variation with more floating parameters than is used for typical metrology modeling. A second set of metrology data is obtained for a second one or more structures on a sample. The second set of metrology data, for example, may be experimental data measured from the second one or more structures or may be synthetic data generated from physical models of the second one or more structures or combination of both. Transfer learning is used from the first machine learning model to the second set of metrology data to produce a second machine learning model for predicting key parameters for the second one or more structures. Key parameters, for example, may include parameters such as geometry dimensions, and physical and material properties of structures on the sample. For example, the model that is trained with synthetic data is transferred to experimental data for inline measurements.

The transfer learning approach is used to improve recipe robustness, reduce the number of reference samples required, and reduce the need to re-collect reference data and recipe re-work when sample manufacture processing changes occur. The transfer leaning approach further has the benefit of reduced recipe creation steps, improved ease of use and faster TTS, particularly for complex devices, such as 3D NANDs. The transfer learning approach discussed herein, for example, may require significantly fewer (2-100×, device and hardware dependent) samples of spectra than is required for conventional library generation which leads to considerably faster TTS and decreased use of computational resources.

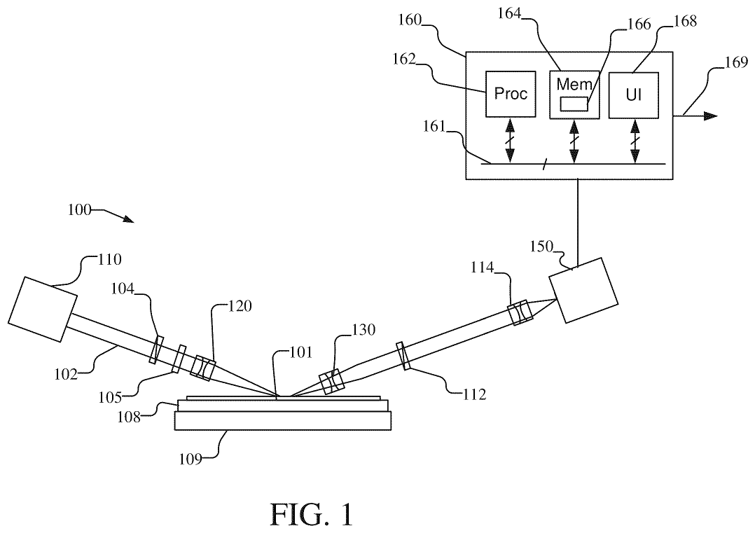

FIG. 1, by way of example, illustrates a schematic view of a non-contact metrology device 100 that may be configured to support measurement of a structure, as described herein. The metrology device 100, for example, may be used to generate metrology data from a test sample and/or reference samples and to process the metrology data as described herein. The metrology device 100 is illustrated as an optical metrology device, but it should be understood that other types of non-contact metrology devices, including X-ray metrology devices may be used. As illustrated, the metrology device 100 may be configured to perform, e.g., spectroscopic reflectometry, spectroscopic ellipsometry (including Mueller matrix ellipsometry), spectroscopic scatterometry, overlay scatterometry, interferometry, or FTIR measurements, of a sample 101 that includes one or more structures to be measured. It should be understood that metrology device 100 is illustrated as one example of a configuration for the metrology device, and that if desired other metrology device configurations may be used, including normal incidence devices, non-polarizing devices, etc.

Metrology device 100 includes a light source 110 that produces light 102. The light 102, for example, UV-visible light with wavelengths, e.g., between 200 nm and 1000 nm. The light 102 produced by light source 110 may include a range of wavelengths, i.e., continuous range or a plurality of discrete wavelengths, or may be a single wavelength. The metrology device 100 includes focusing optics 120 and 130 that focus and receive the light and direct the light to be obliquely incident on a top surface of the sample 101. The optics 120, 130 may be refractive, reflective, or a combination thereof and may be an objective lens.

The reflected light may be focused by lens 114 and received by a detector 150. The detector 150 may be a conventional charge coupled device (CCD), photodiode array, CMOS, or similar type of detector. The detector 150 may be, e.g., a spectrometer if broadband light is used, and detector 150 may generate a spectral signal as a function of wavelength. A spectrometer may be used to disperse the full spectrum of the received light into spectral components across an array of detector pixels. One or more polarizing elements may be in the beam path of the metrology device 100. For example, metrology device 100 may include one or both (or none) of one or more polarizing elements 104 in the beam path before the sample 101, and a polarizing element (analyzer) 112 in the beam path after the sample 101, and may include one or more additional optical elements 105, such as a waveplate, compensator, photoelastic modulator etc., which may be before, after, or both before and after the sample 101.

Metrology device 100 further includes one or more computing systems 160 that is configured to obtain metrology data, which is used to train machine learning models with metrology data for predicting key parameters (such as geometry dimensions, and physical and material properties) of structures on the sample using the methods described herein. For example, the metrology data may be measured data obtained from the detector 150 or may be synthetic metrology data generated based on one or more models. As illustrated, the one or more computing systems 160 may be coupled to the detector 150 to receive measured metrology data acquired by the detector 150 during measurement of the structure of the sample 101. The one or more computing systems 160, for example, may be a workstation, a personal computer, central processing unit or other adequate computer system, or multiple systems. The one or more computing systems 160 may be configured to obtain multiple sets of metrology data for structures on a sample and to train one or more machine learning models with the metrology data for predicting key parameters for the structures, e.g., including using transfer learning, as described herein. The one or more computing systems 160 may be further configured to measure structures under test based on the predicted key parameters.

It should be understood that the one or more computing systems 160 may be a single computer system or multiple separate or linked computer systems, including one or more processors which may be coupled to one or more computational nodes (blades), which may be interchangeably referred to herein as computing system 160, at least one computing system 160, one or more computing systems 160. In some implementations, the computing system 160 may be separate from the metrology device 100 while in some implementations, the computing system 160 may be included in or is connected to or otherwise associated with metrology device 100 or may be separate from the metrology device 100. Different subsystems of the metrology device 100 may each include a computing system that is configured for carrying out steps associated with the associated subsystem. The computing system 160, for example, may control the positioning of the sample 101, e.g., by controlling movement of a stage 109 that is coupled to the chuck. The stage 109, for example, may be capable of horizontal motion in either Cartesian (i.e., X and Y) coordinates, or Polar (i.e., R and θ) coordinates or some combination of the two. The stage may also be capable of vertical motion along the Z coordinate. The computing system 160 may further control the operation of the chuck 108 to hold or release the sample 101. The computing system 160 may further control or monitor, e.g., one or more of the polarizing elements 104, 112, or monitor optical elements 105, etc.

The computing system 160 may be communicatively coupled to the detector 150 in any manner known in the art. For example, the one or more computing systems 160 may be coupled to a separate computing system that is associated with the detector 150. The computing system 160 may be configured to receive and/or acquire metrology data or information from one or more subsystems of the metrology device 100, e.g., the detector 150, as well as control polarizing elements 104, 112, or optical elements 105, etc., by a transmission medium that may include wireline and/or wireless portions. The transmission medium, thus, may serve as a data link between the computing system 160 and other subsystems of the metrology device 100.

The computing system 160 includes at least one processor 162 with memory 164, as well as a user interface (UI) 168, which are communicatively coupled via a bus 161. The memory 164 or other non-transitory computer-usable storage medium, includes computer-readable program code 166 embodied thereof and may be used by the computing system 160 for causing the at least one computing system 160 to control the metrology device 100 and/or to perform functions including the predicting key parameters for the structures as described herein. The data structures and software code for automatically implementing one or more acts described in this detailed description can be implemented by one of ordinary skill in the art in light of the present disclosure and stored, e.g., on a computer-usable storage medium, e.g., memory 164, which may be any device or medium that can store code and/or data for use by a computer system, such as the computing system 160. The computer-usable storage medium may be, but is not limited to, include read-only memory, a random access memory, magnetic and optical storage devices such as disk drives, magnetic tape, etc. Additionally, the functions described herein may be embodied in whole or in part within the circuitry of an application specific integrated circuit (ASIC) or a programmable logic device (PLD), and the functions may be embodied in a computer understandable descriptor language which may be used to create an ASIC or PLD that operates as herein described.

The computing system 160, for example, may be configured to support measurement of a structure on a sample using transfer learning. The at least one processor 162, for example, may obtain metrology data for a first set of structures. The metrology data may be simulated (synthetic) data generated using models of the first set of structures or experimental data measured from the first set of structures, e.g., with the metrology device 100. The at least one processor 162 may train a first machine learning model using the metrology data for the first set of structures. The at least one processor 162 also obtains metrology data for a second set of structures, which are similar to the test structure to be measured. The metrology data for the second set of structures may be experimental data measured, e.g., with the metrology device 100. The at least one processor 162 performs transfer learning from the first machine learning model to the metrology data for the second set of structures to optimize a second machine learning model for predicting the key parameters for the second one or more structures.

In some implementations, the computing system 160 may be configured to support measurement of a structure on a sample using transfer learning with domain adaptation. The at least one processor 162, for example, may obtain a first set of metrology data for a first set of structures as the source and a second set of metrology data for a second set of structures as the target. The first set of metrology data may be simulated (synthetic) data generated using models of the first set of structures or experimental data measured from the first set of structures, e.g., with the metrology device 100, or a combination thereof. The second set of metrology data for the second set of structures may be experimental data measured, e.g., with the metrology device 100, or simulated (synthetic) data generated using models of the second set of structures, or a combination thereof. The at least one processor 162 selects metrology data from the first and second sets of metrology data, e.g., using a feature extractor. For example, metrology data may be selected that can minimize the regression model error for the main training task to predict key parameters and to minimize the difference in the metrology data between the first set of metrology data (source) and second set of metrology data (target). In other examples, the computing system 160 may be configured to support measurement of a structure on a sample using other types of transfer learning, such as instance-based. Instance-based transfer learning may help improve ML performance of target domain by re-weighting the samples in source domain or target domain to correct for distribution differences between two domains.

The results, e.g., trained machine learning models, may be, e.g., stored in memory 164, and/or provided to other devices for measurement of a structure. For example, during measurement, metrology data is obtained from a target structure, e.g., using the metrology device 100. The metrology data is provided to the trained machine learning model to obtain the feature parameters of the structure. The results may be reported and fed forward or back to the process equipment to adjust the appropriate fabrication steps to compensate for any detected variances in the fabrication process. The computing system 160, for example, may include a communication port 169 that may be any type of communication connection, such as to the internet or any other computer network. The communication port 169 may be used to receive instructions that are used to program the computing system 160 to perform any one or more of the functions described herein and/or to export signals, e.g., with measurement results and/or instructions, to another system, such as external process tools, in a feed forward or feedback process in order to adjust a process parameter associated with a fabrication process step of the samples based on the measurement results.

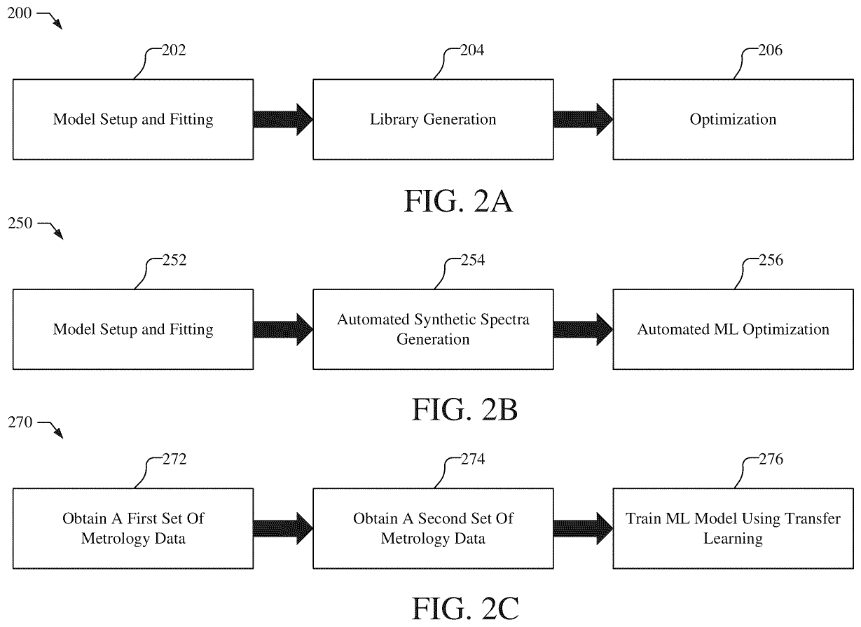

FIG. 2A illustrates a general workflow 200 used in conventional modeling and library generation, e.g., for predicting key parameters. As illustrated, an initial model setup and real time fitting 202 is performed, in which a physical model of the structure is generated based on preliminary structural and material information known about the structure, such as the type of structure, physical description of the structure, materials, etc. The model includes variable parameters, e.g., floating parameters, and fixed parameters. The model includes nominal values for various parameters, such as layer thicknesses, line widths, space widths, sidewall angles, etc., along with ranges for variable parameters, e.g., the ranges within which floating parameters may vary. Real time fitting is used to generate and verify the model. The real time fitting, for example, compares reference data, e.g., data measured from a reference structure with known parameter values (e.g., measured using a transmission electron microscope (TEM) or critical dimension scanning electron microscope (CD-SEM)) to calculated data for the model with the same parameter values. If the comparison between measured data and calculated data for the model is a close fit, e.g., within several nanometers, the model may be assumed to be an accurate representation of the structure. The time required for the initial model setup is dependent on the complexity of the structure, e.g., the number of layers, number of features, number of parameters, etc., as well as the number of reference structures used for fitting.

Once the model is setup, library generation 204 may then be performed. During library generation, the variable parameters are varied, and data is calculated for each variation to generate a collection of data associated with parameter values for the model. The time required for library generation is likewise dependent on the complexity of the structure, as well as the size of the variable parameter ranges, and the desired resolution of the library. For example, a sample with many variable parameters, each of which is individually varied over its full range, will have a large number of permutations, while a sample with few variable parameters will have a significantly smaller number of permutations. Similarly, if the library is generated with large variable parameter ranges or with high resolution, i.e., a large number of possible values within each variable parameter range, there will be a larger number of permutations relative to small variable parameter ranges or low resolution. Even with a modest number of variable parameters, with limited ranges and resolution, the number of distinct models (each having a different permutation of parameters) for which data must be calculated can be in the hundreds or thousands, requiring many hours or days to generate a useful library. Accordingly, the library resolution and variable parameter ranges may be limited for practical considerations, which limits the robustness of the library.

Following library generation 204, post library recipe optimization 206 is performed, in which the details of the recipe such as float parameters and fixed parameters are further optimized using the library so that the reported measurement results for critical parameters from the recipe can match the reference results within a desired tolerance, usually sub-nanometer. The time required for post library optimization is dependent on the size of the reference samples and the complexity of the model.

As can be inferred, the TTS for conventional library generation is generally quite long, e.g., days or weeks for complex structures. Moreover, the accuracy of the model may be impaired for complex structures for which there may be a large misfit during model setup and real time fitting 202, e.g., it is difficult to achieve a good correlation between calculated data to reference data for a complex structure even after post library optimization. Further, robustness may suffer from model assumptions, such as fixed and coupled parameters, as well as practical considerations to reduce the number of model variants.

Other measurement techniques may be used to avoid the need for generation of a full library. For example, pure machine learning (ML) may be used, which provides a faster TTS. Pure ML, however, requires a large amount of reference data, which is costly to acquire. Without a large amount of reference data, robustness, as well as accuracy, may be compromised.

Additionally, as discussed above, after conventional library generation, the process used to fabricate the structures may vary over time. If, for example, limited variable parameter ranges were used during the initial model setup and real time fitting, process variations for fabrication of the structures may degrade the accuracy and utility of a library. Consequently, additional libraries may need to be generated and the recipe needs to be re-optimized with newly generated library over time due to process variations.

FIG. 2B illustrates workflow 250 illustrating one implementation of modeling and predicting key parameters, as described herein. The workflow 250 bypasses library generation, with the benefit of less recipe creation steps, faster TTS, and ease of use.

The modeling and data analysis described herein, for which workflow 250 illustrates one implementation, applies transfer learning to train a model with source domain data that can be transferred to a target domain and facilitate model training for target domain for faster time to solution, improved recipe robustness and generalizability, as well as reduced number of reference data samples, relative to the process illustrated in FIG. 2A. For example, where a conventional process may require days or weeks for TTS, the present modeling and data analysis may be performed in less than a day, with notable improvements in robustness and generalizability, case of use, and reference data requirements.

As illustrated in FIG. 2B, initial model setup and real time fitting 252 is performed, which may be the same or similar to the initial model setup and real time fitting 202 in workflow 200 shown in FIG. 2A. During the initial model setup and real time fitting 252, a physical model of the structure may be generated based on preliminary structural and material information known about the structure, such as the type of structure, physical description of the structure with nominal values for various parameters, such as layer thicknesses, line widths, space widths, sidewall angles, etc., along with one or more variable parameters, e.g., the ranges within which parameters may vary. Real time fitting is used to generate and verify the model. The real time fitting, for example, compares reference data, e.g., data measured from a reference structure with known parameter values to calculated data for the model with the same parameter values. If the comparison between measured data and calculated data for the model is a close fit, the model may be assumed to be an accurate representation of the structure.

In some implementations, the initial model setup and real time fitting 252 may include one or more multiple models and may cover large process variations relative to the model generated in the initial model setup and real time fitting 202. For example, the models may cover process variations that cannot be covered by provided experimental data (reference data). The process window may be estimated by users from previous experience, or from a simulated process window using process simulation software. The model(s) may be for complex structures, such as 3D-NAND or other logic devices, dynamic random access memory (DRAM), etc.), for any type of metrology tool or combination of signal from multiple tools.

Automated synthetic spectra generation 254 is used to generate synthetic spectra from one or multiple models to cover large process variations. Synthetic data, for example, may be information that is artificially created, e.g., using one or more models from initial model setup and real time fitting 252, rather than being measured from reference samples. The synthetic spectra may cover larger process variations, but may be significantly more sparse, than is used in conventional library generation, and consequently, the automated synthetic spectra generation 254 process may be substantially faster than the library generation 204, e.g., up to 40 times faster.

While workflow 250 illustrates generation of synthetic spectra, it should be understood any desired type of synthetic metrology data may be used. The synthetic metrology data may be labeled or unlabeled or a combination thereof. Moreover, the workflow 250 is not limited to synthetic data. For example, measurements of one or more reference structures may be used to generate metrology data, e.g., experimental metrology data, instead of generating synthetic metrology data from one or more models generated from the initial model setup and real time fitting 252. The experimental metrology data measured from the one or more models may be labeled or unlabeled or a combination thereof. With use of experimental metrology data, the model setup and real time fitting 252 and automated synthetic spectra generation 254 may be obviated. In some implementations, both synthetic metrology data and experimental metrology data, which may be labeled, may be generated. Moreover, the synthetic metrology data and the experimental metrology data may be interchangeable with respect to target or source domains. For example, the source domain may be any of synthetic metrology data, experimental metrology data, or a combination of synthetic metrology data and experimental metrology data, whereas the target domain may be any of synthetic metrology data, experimental metrology data, or a combination of synthetic metrology data and experimental metrology data.

Automated machine learning (ML) optimization 256 is used to generate key parameter predictions based on the synthetic spectra from the automated synthetic spectra generation 254 (i.e., synthetic metrology data) or experimental metrology data. The automated ML optimization includes a transfer learning approach that develop a recipe for one or more first targets and apply it to one or more second targets of similar structures but with small difference such as pitch, material properties, or minor geometry changes, with benefit of reducing required reference and faster TTS for the second set of targets recipe creation facilitated by the knowledge learned from first set of targets recipe creation.

The modeling and predicting key parameters, illustrated in workflow 250, and described herein, effectively reduces the TTS of metrology solutions for complex structures, such as 3D-NAND, from 1-2 weeks for conventional workflows, such as illustrated in FIG. 2A, to a day or less. Moreover, the resulting modeling and predicting key parameters has improved robustness, generalizability, and ease-of-use (e.g., less tuning knobs and floating/fixed parameters through automation) than resulting from conventional library generation approaches. With respect to pure ML approaches, the workflow 250 exhibits less reliance on experimental reference data with improved recipe robustness. Further, the recipe creation steps required are reduced and less user experience is necessary to develop a high quality recipe. For example, practical considerations limiting the number of floating parameters for modeling is relaxed so that large process variation may be covered. Further, while one or more physical models may be used, e.g., to generate synthetic metrology data, the required model fidelity and fit quality may be lower compared to conventional modeling approaches. Additionally, recipe robustness with respect to process variations (resulting in measured metrology data changes over time) is maintained by retraining the model with unlabeled metrology data or adding synthetic metrology data without the need for new reference data.

The ML optimization 256 may use transfer learning for the metrology data, in which a first ML model is trained using synthetic (and/or experimental) metrology data with or without reference data, e.g., from a TEM or CDSEM. Transfer learning is performed from the first ML model to a second set of metrology data, which may be experimental, synthetic, or a combination thereof, to optimize a second ML model that can be used to predict measurement results for experimental metrology data. In some implementations, the first and second ML models may be co-optimized or co-trained based on the first set of metrology data and the second set of metrology data and merged into a single ML model. The transfer learning process for metrology data greatly reduces reliance on reference data. Moreover, in some implementations, one set of the metrology data may be fully unlabeled (no reference employed), e.g., using domain adaptation. In some implementations, other types of transfer learning may be used, such as instance-based.

FIG. 2C illustrates workflow 270 showing a generalized implementation of modeling and predicting key parameters, as described herein. Workflow 270, for example, may be similar to workflow 250 and bypasses library generation shown in workflow 200, with the benefit of less recipe creation steps, faster TTS, and ease of use.

As illustrated in FIG. 2C, workflow 270 obtains a first set of metrology data 272 from one or more first structures. The first set of metrology data may be spectral data or any other desired data and may be synthetic metrology data, experimental metrology data, or a combination thereof. For example, the first set of metrology data may be source data or target data to be used in a machine learning process. The first one or more structures may be a single structure or a set of structures, and may be different types of structures or are a same type of structures produced using a same or different processes. Obtaining a first set of metrology data 272, for example, may be similar to the model setup and real time fitting 252 and automated synthetic spectra generation 254 shown in FIG. 2B to produce synthetic metrology data, e.g., using an initial model setup and real time fitting for one or more models of the one or more first structures and generating synthetic metrology data from one or multiple models to cover relatively large variations in structural parameters, layer property parameters, material property parameters, or a combination thereof. Additionally or alternatively, as described above, obtaining a first set of metrology data 272, for example, may be performed by measuring the one or more first structures to generate experimental metrology data.

As illustrated, the workflow 270 obtains a second set of metrology data 274 from one or more second structures. The second set of metrology data may be spectral data or any other desired data and may be synthetic metrology data, experimental metrology data, or a combination thereof. For example, the second set of metrology data may be target data or source data to be used in a machine learning process. The second one or more structures may be a single structure or a set of structures, and may be different types of structures or are a same type of structures produced using a same or different processes. Obtaining a second set of metrology data 274, for example, may be performed by measuring the one or more second structures to generate experimental metrology data. Additionally or alternatively, as described above, obtaining a second set of metrology data 274, for example, may be performed by producing synthetic metrology data, e.g., using an initial model setup and real time fitting for one or more models of the one or more second structures and generating synthetic metrology data from one or multiple models, e.g., similar to the model setup and real time fitting 252 and automated synthetic spectra generation 254 shown in FIG. 2B to produce synthetic metrology data. The variations in structural parameters, layer property parameters, material property parameters, or a combination thereof, covered by the second set of metrology data may be less than for the first set of metrology data.

The workflow 270 trains a machine learning model using transfer learning 276 based on the first set of metrology data and the second set of metrology data. For example, a first model may be trained based on metrology data in the source domain, e.g., the first set of metrology data, and the first model may be transferred using a parameter-based transfer learning process, to metrology data in the target domain, e.g., the second set of metrology data, to produce a second machine learning model for predicting key parameters for the one or more second structures. With the parameter-based transfer learning process, both the source and target domains include labelled data, e.g., both the source domain and the target domain include at least partially labelled data. In another implementation, the first set of metrology data and the second set of metrology data may be used to train a machine learning model using transfer learning with domain adaptation to produce a machine learning model for predicting key parameters for the one or more second structures. With domain adaptation, for example, the source domain and target domain may have different feature spaces and distributions, and the process generally attempts to alter both a source domain and target domain to bring the distribution of the source domain and target domain closer to improve the performance of training a target ML model. With transfer learning using domain adaptation, only one of the source domain and target domain includes at least partially labeled data, while the remaining domain includes labeled, unlabeled, or a combination of labeled and unlabeled data.

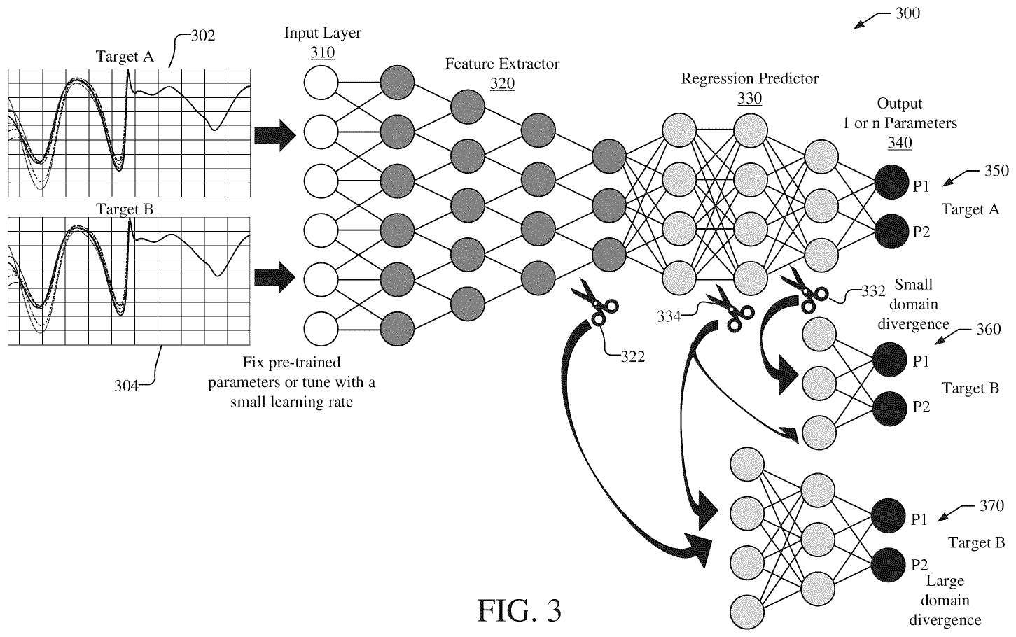

FIG. 3 illustrates an example of transfer learning process 300 for metrology data that may be used, e.g., for the ML optimization 256 shown in FIG. 2B and training a machine learning model using transfer learning 276 shown in FIG. 2C. As illustrated, transfer learning is performed from a first ML model 350 (with readily available inputs and labels) for target A, which is used to optimize one or more second ML model(s) 360 and 370 (with few number of inputs and labels) to predict measurement results for a target B. In some implementations, the transfer learning process 300 may be adapted to be performed with respect to more than two targets. For example, there may be one or more targets used to train the first ML model 350 and there may be one or more targets for the one or more second ML model(s) 360 and 370. The transfer learning process 300 shown in FIG. 3, which is sometimes referred to as parameter-based transfer learning, includes at least some labelled data for all domains (source domains and target domains). If there are more than two domains and some domains have no labeled data, the data from these unlabeled domains may be combined with labeled data from other domain(s) to train one of the ML models.

As illustrated, metrology data 302 for target A is provided to input layer to a feature extractor 320 as the source domain. The metrology data 302 for target A may be synthetic metrology data generated using one or more models for target A or experimental metrology data measured from target A, or a combination of synthetic metrology data and experimental metrology data. The metrology data 302 for target A is at least partially labeled. The target A may be one or more structures, e.g., one or more models of one or more structures generated from the initial model setup and real time fitting 252 in FIG. 2B used to produce synthetic metrology data or one or more reference structures that are measured to generate experimental metrology data and as described in obtaining a first set of metrology data 272 in FIG. 2C. The feature extractor 320 may be any linear or non-linear feature extraction architecture such as, but not limited to convolutional neural networks, shallow neural network, deep learning, any other machine learning model that may be co-optimized on both source and target data, or any combination thereof. The feature extractor 320 is coupled to a regression predictor 330, which provides 1 to n parameters at an output layer 340, illustrated as parameters P1 and P2 for target A for the first ML model 350. The output parameters P1 and P2, for example, may be structural parameters or layer parameters such as critical dimensions (CDs), height, thickness, depth, line widths, space widths, sidewall angles, etch recess, tilting, overlay, surface roughness, line edge roughness etc., or material properties such as doping concentrations, composition, crystallinity, electrical conductivity etc.

As further illustrated, metrology data 304 for target B is provided to input layer 310 to a feature extractor 320 as the target domain. The metrology data 304 for target B may be experimental metrology data measured from target B or synthetic metrology data generated using one or more models for target B, or a combination of experimental metrology data and synthetic metrology data. The experimental metrology data and synthetic metrology data are at least partially labeled. Similar to target A, the target B may be one or more structures, e.g., one or more models of one or more structures generated from modeling to produce synthetic metrology data or one or more physical structures that are measured to generate experimental metrology data, e.g., as described in obtaining a second set of metrology data 274 in FIG. 2C. By way of example, each of target A and target B may be a same structure type that is produced using a same or different process. For example, target A and target B may be a single type of structure from the same process step but with different process conditions such as chemical concentrations, etch time, gas pressure etc. In another example, each of target A and target B may be multiple structure types that are produced using a same process or different process. In another example, target A may be a first set of structures and target B may be a second set of structures and the first set of structures and the second set of structures may include the same or different structures.

For the transfer learning, two approaches may be used. The first model may be static except for one or more of the last layers, e.g., by fixing their parameters, which are pre-trained on metrology data 302 for target A. In another approach, one or more first few layers of the model may have more flexibility and may be trained with a smaller learning rate using metrology data 304 for target B. Since the knowledge learned from target A is transferred to target B through the shared parameters in the learner model, i.e., one or more of the first few layers are kept static or re-trained with a smaller learning rate, this type of transfer learning is referred as parameter-based transfer learning.

As illustrated by scissors 332, 334 and 322, the transfer learning may be applied at different layers in the regression predictor 330 or feature extractor 320 to produce the output layer 340 for target B, illustrated as parameters P1 and P2, for a second ML model 360 with small domain divergence or for a third ML model 370 with a large domain divergence. The parameters P1 and P2 for models 360 and 370, for example, may be the same output parameters for model 350. With increasing domain divergence, generally more layers have to be retrained from the first model.

In some implementations, the transfer learning process 300 may use more than two targets. For example, multiple targets may be used to train the first ML model 350. In another example, an additional target (target C (not shown)) may be used to train an additional ML model, e.g., the metrology data 302 for target A is used to train a first ML model 350 and the additional set of metrology data for target C is used to train a third ML model. The knowledge of the first ML model 350 and the knowledge of the third ML model may be transferred to the second ML model (e.g., model 360/370) trained with the metrology data 304 from target B. In some implementations, different segments from the machine learning models may be transferred to the second machine learning model. For example, one or more of the first few layers from the first ML model 350 may be kept static or trained with a smaller learning rate using the metrology data 304 from target B for the second ML model 360/370, and one or more middle layers or one or more last few layers from the third ML model (for target C) may be kept static or trained with smaller learning rate using the metrology data 304 from target B for the second ML model 360/370. The training of the first ML model 350 using metrology data 302 for target A and the training of the third ML model using the additional set of metrology data for target C may be completely independent or transfer learning may be performed between them. Additionally, in some implementations, the first ML model 350 and the second ML model (360/370) may be used to train a third ML model, e.g., by transferring learning to the additional set of metrology data for target C. In some implementations, different segments from the machine learning models may be transferred to the third machine learning model. For example, one or more of the first few layers from the first ML model 350 may be kept static or trained with a smaller learning rate using the metrology data from target C for the third ML model, and one or more middle layers or one or more last few layers from the second ML model (for target B) may be kept static or trained with smaller learning rate using the metrology data from target C for the third ML model.

In some implementations, the first ML model and the second ML model may be co-optimized and merged into a single ML model.

In another implementation, transfer learning with domain adaptation may be used for metrology data, e.g., as discussed in reference to the ML optimization 256 shown in FIG. 2B and training machine learning model using transfer learning 276 in FIG. 2C.

Domain adaptation is a transfer learning scenario where the source and target domains have different feature spaces and distributions. With domain adaptation, the process adapts one or more source domains to transfer information to improve the performance of training a target ML model. Thus, the process generally attempts to alter the semantic representation of both a source domain and target domain to bring the distribution of the source and target closer.

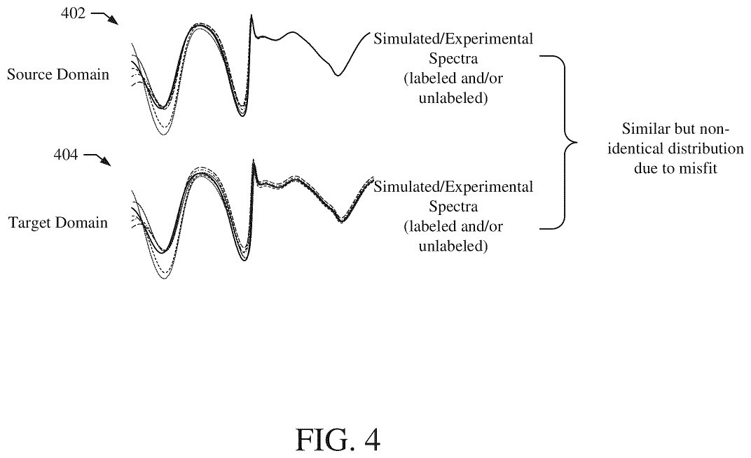

FIG. 4, by way of example, illustrates an example of a source domain 402 and target domain 404 in the form of spectra. While two domains are illustrated in FIG. 4, it should be understood that there may be more than two domains. The source domain 402, for example, may be simulated (synthetic) or experimental spectra, or a combination thereof, which may be labeled or unlabeled, or a combination thereof, and the target domain 404 may be experimental spectra or simulated (synthetic) or a combination thereof, which may be labeled, unlabeled, or a combination thereof as described with respect to obtaining a first set of metrology data 272 and obtaining a second set of data 274 in FIG. 2C. By way of example, in one implementation, the source domain may have unlabeled synthetic or experimental data and target domain may have labeled experimental data. In this example, a regressor may be trained using the target domain data, where the purpose of the unlabeled data from the source domain is to promote invariance of common features between the source and target domains with the source domain covering a larger process variation from unlabeled data. In another implementation, the source domain may have labeled synthetic or experimental data and target domain may have unlabeled experimental data. The target domain may also include limited number of labeled data. In this example, a regressor may be trained using the source domain data combined with the labeled data from target domain if available, where the purpose of the unlabeled data from the target domain is to promote invariance of common features between the source and target domains with the target domain covering a larger process variation from unlabeled data with benefit of reduced requirement on reference data. It should be understood that the source domain 402 and target domain 404 are not limited to spectra but that other metrology data may be used as desired. The source domain 402 and the target domain 404 may be similar but may have a non-identical distribution, e.g., due to misfit during the initial model setup and real time fitting 252. Additionally, if both source and target include experimental data, the distribution difference may be due to the different fabrication process. Thus, if source and target domains are collected from different structures with common key parameters, the domain difference may be from the structural differences.

In addition to or in the alternative to using regression with supervised machine learning where the key parameter(s) are continuous real values, classification may be used with supervised machine learning where the key parameter(s) are categorical, for example, to diagnose good (likely to pass electrical test)/bad (likely to fail electrical test) dies.

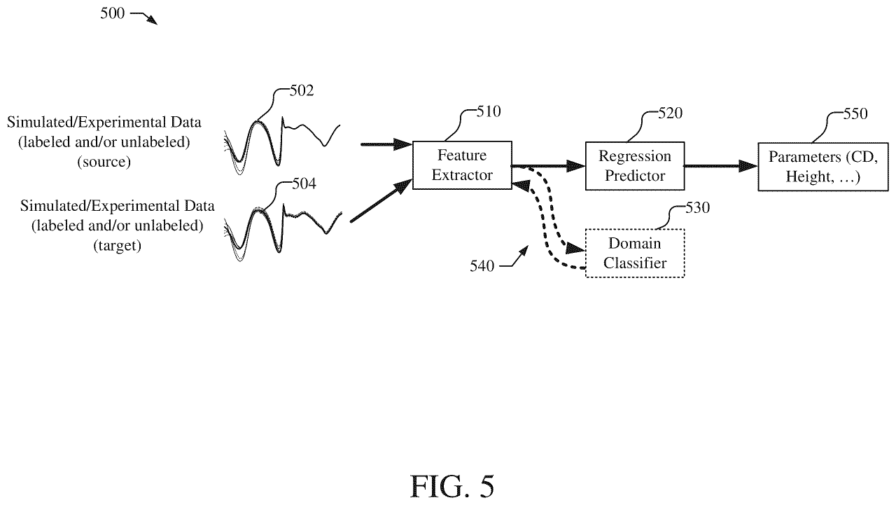

FIG. 5 illustrates an example of transfer learning with domain adaptation process 500 for metrology data that may be used, e.g., as discussed in reference to the ML optimization 256 shown in FIG. 2B and training machine learning model using transfer learning 276 in FIG. 2C. The transfer learning process 500 with domain adaptation shown in FIG. 5 does not need to necessarily have labelled data in all domains, e.g., only one domain has at least some labels. As illustrated, metrology data 502, which may be labeled and/or unlabeled simulated and/or experimental metrology data, and metrology data 504, which may be labeled and/or unlabeled simulated and/or experimental metrology data, are provided to a feature extractor 510, as described with respect to obtaining a first set of metrology data 272 and obtaining a second set of metrology data 274 in FIG. 2C. While FIG. 5 illustrates the metrology data 502 and 504 as spectra, as discussed in reference to FIG. 4, the metrology data 502 and 504 are not limited to spectra and may be other metrology data. The feature extractor 510 may be any linear or non-linear feature extraction architecture such as, but not limited to convolutional neural networks, shallow neural network, deep learning, or any combination thereof. The feature extractor 510 is coupled to a regression predictor 520, which provides parameters at an output layer 550, e.g., structural parameters or layer parameters such as critical dimensions (CDs), height, thickness, depth, line widths, space widths, sidewall angles, etch recess, tilting, overlay, surface roughness, line edge roughness etc., or material properties such as doping concentrations, composition, crystallinity, electrical conductivity etc. The feature extractor 510 selects metrology data from the metrology data 502 and the metrology data 504 to be used by the regression predictor 520. In implementations where a domain classifier 530 is not used, minimization of the divergence between the source and target domains is a result of co-training (i.e., minimization of regressor loss).

In some implementations, the feature extractor 510 is coupled to a domain classifier 530 via a gradient reversal layer 540, i.e., to perform a feature-based transfer learning process. The domain classifier 530 and gradient reversal layer 540 promotes selection of “good” features from the metrology data, e.g., that can (i) minimize the regression model error for the main training task to predict key parameters and (ii) minimize the difference in the metrology data between the metrology data 502 (source), which may be simulated or experimental metrology data, and metrology data 504 (target), which may be simulated or experimental metrology data.

In some implementations, the transfer learning with domain adaptation process 500 may use more than two targets, e.g., using three or more sets of metrology data. For example, for domain adaptation using three or more sets of metrology data, the domain classifier 530 performs task of multiclass classification instead of binary classification for the case of two sets of metrology data (as illustrated in FIG. 5). In an implementation using co-training, e.g., when the domain classifier 530 is bypassed, using three or more sets of metrology data is not different than considering the first one or more structures as including multiple structures with multiple sets of metrology data.

In some implementations, a transfer learning process for metrology data may include multiple types of transfer learning by way of hybridization. For example, the parameter-based transfer learning process 300 shown in FIG. 3 may be combined with the transfer learning with domain adaptation process 500 shown in FIG. 5. For example, the first ML model 350 and/or the second ML model 360/370 may include a domain classifier referenced in the feature-based transfer learning with domain adaptation process illustrated in FIG. 5. In an example of transfer learning process performed for three targets, one or more layers from the feature extractor 320 may be transferred from the first ML model 350 and one or more layers from a domain classifier or regression predictor 330 may be transferred from the third ML model (for target C) to the second ML model (for target B). Re-weighted labelled samples of all the domains may be used as the input to a model or models with domain adaptation using instance-based transfer learning. By way of further example, a transfer learning process for metrology data may include two or more of the parameter-based transfer learning, feature-based transfer learning, and instance-based transfer learning, as discussed herein.

The transfer learning process for metrology data, e.g., as illustrated in FIGS. 3 and 5, may be used to transfer between source domain and target domain in at least the following scenarios: synthetic data to synthetic data and/or experimental data (labeled and/or unlabeled) for a single structure from the same or different process, labeled experimental data to unlabeled synthetic data and/or experimental data for a single structure from the same or different process, synthetic data and labeled experimental data (co-train) to synthetic data and/or experimental data (labeled and/or unlabeled) for a single structure from the same or different process, or synthetic data and/or experimental data (labeled and/or unlabeled) of one or multiple structures to synthetic data and/or experimental data (labeled and/or unlabeled) of one or multiple similar, but not identical structures from the same or different process.

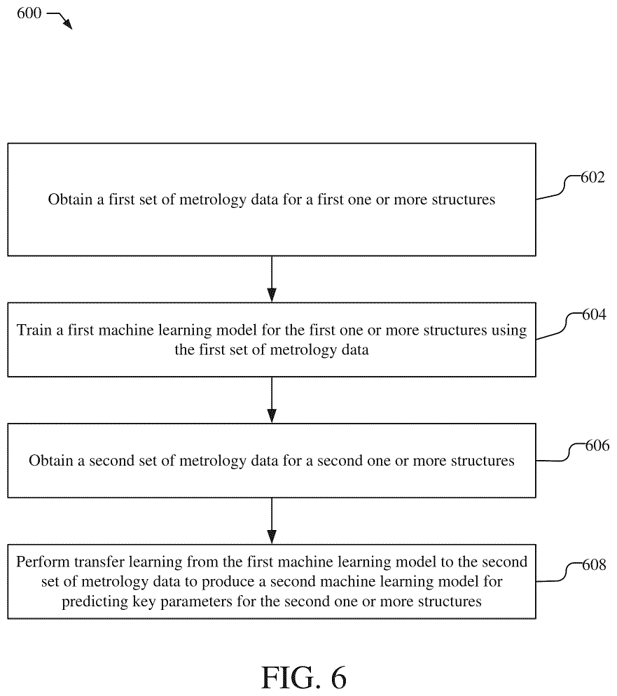

FIG. 6 shows an illustrative flowchart depicting an example operation 600 for supporting non-contact measurement of structures, according to some implementations. In some implementations, the example operation 600 may be performed by one or more processors, e.g., such as at least one processor 162 in at least one computing system 160 in FIG. 1. The non-contact measurement uses metrology data, and may be, for example, optical measurement using optical metrology data, but is not necessarily so limited unless specifically stated. For example, in some implementations, the non-contact measurement may be X-ray measurement using X-ray metrology data or any other desired non-contact measurement, e.g., in which radiation is used.

The one or more processors may obtain a first set of metrology data for a first one or more structures (602). For example, the first set of metrology data may be synthetic metrology data, e.g., generated based on modeling one or more reference structures as described with respect to the automated synthetic spectra generation 254 in workflow 250 shown in FIG. 2B, obtaining the first set of metrology data 272 shown in FIG. 2C, and may be metrology data 302 as discussed in reference to FIG. 3. In another example, the first set of metrology data may be experimental metrology data, e.g., produced by an metrology device, such as metrology device 100 shown in FIG. 1, measuring one or more reference structures, e.g., as referenced in workflow 250 shown in FIG. 2B, obtaining the first set of metrology data 272 shown in FIG. 2C, and may be metrology data 302 as discussed in reference to FIG. 3. In some implementations, the first set of metrology data may be a combination of synthetic metrology data and experimental metrology data. The first set of metrology data may be labeled, unlabeled, or a combination thereof.

The one or more processors may train a first machine learning model for the first one or more structures using the first set of metrology data (604). For example, a first machine learning model 350, as illustrated in FIG. 3, may be trained using the metrology data 302.

The one or more processors may obtain a second set of metrology data for a second one or more structures (606). In some implementations, one of the first set of one or more structures or the second one or more structures includes larger variations in structural parameters, or layer property parameters, or material property parameters, or a combination thereof, than an other of the first one or more structures or the second one or more structures, e.g., the first set of one or more structures may be the result of larger fabrication process variations than used for the second one or more structures. For example, the first set of one or more structures may include larger variations in structural parameters, or layer property parameters, or material property parameters, or a combination thereof, than the second one or more structures, or in another example, the second set of one or more structures may include larger variations in structural parameters, or layer property parameters, or material property parameters, or a combination thereof, than the first one or more structures. The second set of metrology data may be experimental metrology data, e.g., produced by an metrology device, such as metrology device 100 shown in FIG. 1, measuring the second one or more structures, e.g., as referenced in the ML optimization 256 in workflow 250 shown in FIG. 2B, obtaining the second set of metrology data 274 shown in FIG. 2C, and may be metrology data 304 as discussed in reference to FIG. 3. The second set of metrology data may be synthetic metrology data, e.g., generated based on modeling the second one or more structures, e.g., as referenced in obtaining the second set of metrology data 274 shown in FIG. 2C, and may be metrology data 304 as discussed in reference to FIG. 3. In some implementations, the second set of metrology data may be a combination of synthetic metrology data and experimental metrology data. The second set of metrology data may be labeled, unlabeled, or a combination thereof.

The one or more processors perform transfer learning from the first machine learning model to the second set of metrology data to produce a second machine learning model for predicting key parameters for the second one or more structures (608). The transfer learning from the first machine learning model to the second set of metrology data to produce a second machine learning model for predicting key parameters for the second one or more structures, for example, is discussed in ML optimization 256 in workflow 250 shown in FIG. 2B, training machine learning model using transfer learning 276 shown in FIG. 2C, and transfer learning process 300 shown in FIG. 3.

In some implementations, the first set of metrology data may be synthetic metrology data generated from one or more models of the first one or more structures, experimental metrology data generated from the first one or more structures, or a combination thereof.

In some implementations, the second set of metrology data may be synthetic metrology data generated from one or more models of the second one or more structures, experimental metrology data generated from the second one or more structures, or a combination thereof.

In some implementations, at least a portion of the first set of metrology data is labeled and at least a portion of the second set of metrology data is labeled.

In some implementations, the first one or more structures may be a single structure or a set of structures and the second one or more structures may be a single structure or a set of structures.

In some implementations, the first one or more structures and the second one or more structures are different types of structures or are a same type of structures produced using a same or different processes.

In some implementations, the first one or more structures may be a first single structure and the second one or more structures may be a second single structure. In some implementations, the first single structure and the second single structure may be the same type of structure produced using a same or different process. In some implementations, the first single structure and the second single structure are different types of structures.

In some implementations, the first one or more structures may be a first set of structures and the second one or more structures may be a second set of structures. In some implementations, the first set of structures and the second set of structures may be same types of structures produced using a same or different process. In some implementations, the first set of structures and the second set of structures are different types of structures. In some implementations the set of structures may include a single structure while in other implementations, the set of structure may include a plurality of structures, e.g., the first one or more structures may be a single structure and the second one or more structures may be a plurality of structures, or conversely the first one or more structures may be a plurality of structures and the second one or more structures may be a single structure.

In one implementation, one or more processors may further obtain a third set of metrology data for a third one or more structures and train a third machine learning model for the third one or more structures using the third set of metrology data. The one or more processors may further perform transfer learning from the third machine learning model with the first machine learning model (simultaneously or sequentially) to the second set of metrology data to produce the second machine learning model for predicting key parameters for the second one or more structures. For example, the first machine learning model and the third machine learning model may be transferred to the second machine learning model by transferring segments (layers or combinations of layers). In some implementations, different segments from the machine learning models may be transferred to the second machine learning model, for example, one or more layers from the feature extractor may be transferred from the first machine learning model and one or more layers from the domain classifier may be transferred from the third machine learning model.

In one implementation, one or more processors may obtain a third set of metrology data for a third one or more structures and performing transfer learning from the first machine learning model and the second machine learning model to the third set of metrology data to produce a third machine learning model for predicting key parameters for the third one or more structures. In some implementations, different segments from the machine learning models may be transferred to the third machine learning model, for example, one or more layers from the feature extractor may be transferred from the first machine learning model and one or more layers from the domain classifier may be transferred from the second machine learning model.

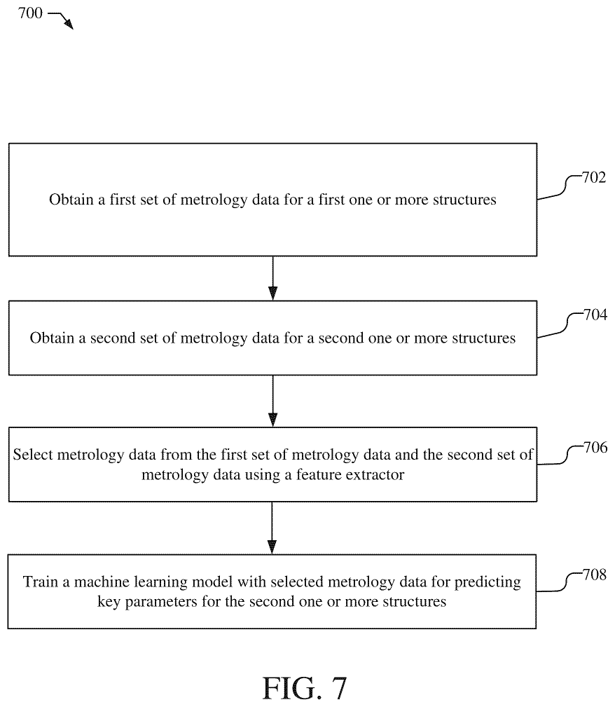

FIG. 7 shows an illustrative flowchart depicting an example operation 700 for supporting non-contact measurement of structures, according to some implementations. In some implementations, the example operation 700 may be performed by one or more processors, e.g., such as at least one processor 162 in at least one computing system 160 in FIG. 1. The non-contact measurement uses metrology data, and may be, for example, optical measurement using optical metrology data, but is not necessarily so limited unless specifically stated. For example, in some implementations, the non-contact measurement may be X-ray measurement using X-ray metrology data or any other desired non-contact measurement, e.g., in which radiation is used.

The one or more processors may obtain, as a source domain, a first set of metrology data for a first one or more structures (702). For example, the first set of metrology data may be synthetic metrology data, e.g., generated based on modeling one or more reference structures as described in the automated synthetic spectra generation 254 in workflow 250 shown in FIG. 2B, obtaining the first set of metrology data 272 shown in FIG. 2C, and may be metrology data of the source domain 402, or the metrology data 502 (source) as discussed in reference to FIGS. 4 and 5. In another example, the first set of metrology data may be experimental metrology data, e.g., produced by an metrology device, such as metrology device 100 shown in FIG. 1, measuring one or more reference structures, e.g., as referenced in workflow 250 shown in FIG. 2B, obtaining the first set of metrology data 272 shown in FIG. 2C, and may be metrology data of the source domain 402, or the metrology data 502 (source) as discussed in reference to FIGS. 4 and 5. In some implementations, the first set of metrology data may be a combination of synthetic metrology data and experimental metrology data. The first set of metrology data may be labeled, unlabeled, or a combination thereof.

The one or more processors may obtain a second set of metrology data for a second one or more structures (704). The second set of metrology data may be experimental metrology data, e.g., produced by an metrology device, such as metrology device 100 shown in FIG. 1, measuring one or more structures, e.g., as referenced in the ML optimization 256 in workflow 250 shown in FIG. 2B, obtaining the second set of metrology data 274 shown in FIG. 2C, and may be metrology data of the target domain 404, or the metrology data 504 (target) as discussed in reference to FIGS. 4 and 5. The second set of metrology data may be synthetic metrology data, e.g., generated based on modeling the second one or more structures, e.g., as referenced in obtaining the second set of metrology data 274 shown in FIG. 2C, and may be metrology data of the target domain 404, or the metrology data 504 (target) as discussed in reference to FIGS. 4 and 5, respectively. In some implementations, the second set of metrology data may be a combination of synthetic metrology data and experimental metrology data. The second set of metrology data may be labeled, unlabeled, or a combination thereof.

The one or more processors select metrology data from the first set of metrology data and the second set of metrology data using a feature extractor (706). The selection of metrology data may be performed using the feature extractor 510 as discussed in reference to FIG. 5.

The one or more processors train a machine learning model with selected metrology data for predicting key parameters for the second one or more structures (708), e.g., as referenced in training a machine learning model using transfer learning 276 shown in FIG. 2C. For example, the machine learning model, as illustrated in FIG. 5, may be trained using the selected metrology data.

In some implementations, the one or more processors minimize domain differences between the first set of metrology data and the second set of metrology data, as discussed in reference to FIG. 5. For example, the one or more processors may minimize the domain differences using a domain classifier 530 via a gradient reversal layer 540 as shown in FIG. 5.

In some implementations, the one or more processors minimize domain differences by co-training based on the first set of metrology data and the second set of metrology data, as discussed in reference to FIG. 5.

In some implementations, the first set of metrology data may be synthetic metrology data generated from one or more models of the first one or more structures, experimental metrology data generated from the first one or more structures, or a combination thereof.

In some implementations, the second set of metrology data may be synthetic metrology data generated from one or more models of the second one or more structures, experimental metrology data generated from the second one or more structures, or a combination thereof.

In some implementations, the first set of metrology data is at least partially labeled and the second set of metrology data is labeled, unlabeled, or a combination thereof. In some implementations, the second set of metrology data is at least partially labeled and the first set of metrology data is labeled, unlabeled, or a combination thereof.

In some implementations, the first one or more structures may be a single structure or a set of structures and the second one or more structures may be a single structure or a set of structures.

In some implementations, the first one or more structures and the second one or more structures are different types of structures or are a same type of structures produced using a same or different processes.

In some implementations, the first one or more structures may be a first single structure and the second one or more structures may be a second single structure. In some implementations, the first single structure and the second single structure may be the same type of structure produced using a same or different process. In some implementations, the first single structure and the second single structure are different types of structures.

In some implementations, the first one or more structures may be a first set of structures and the second one or more structures may be a second set of structures. In some implementations, the first set of structures and the second set of structures may be same types of structures produced using a same or different process. In some implementations, the first set of structures and the second set of structures are different types of structures. In some implementations the set of structures may include a single structure while in other implementations, the set of structure may include a plurality of structures, e.g. the first one or more structures may be a single structure and the second one or more structures may be a plurality of structures, or conversely the first one or more structures may be a plurality of structures and the second one or more structures may be a single structure.

In some implementations, the one or more processors obtain a third set of metrology data for a third one or more structures, and select metrology data from the third set of metrology data with the first set of metrology data and the second set of metrology data using the feature extractor.

The above description is intended to be illustrative, and not restrictive. For example, the above-described examples (or one or more aspects thereof) may be used in combination with each other. Other implementations can be used, such as by one of ordinary skill in the art upon reviewing the above description. Also, various features may be grouped together and less than all features of a particular disclosed implementation may be used. Thus, the following aspects are hereby incorporated into the above description as examples or implementations, with each aspect standing on its own as a separate implementation, and it is contemplated that such implementations can be combined with each other in various combinations or permutations. Therefore, the spirit and scope of the appended claims should not be limited to the foregoing description.

What is claimed is:

1. A method for supporting non-contact measurement of a structure, the method comprising:
obtaining a first set of metrology data for a first one or more structures;
training a first machine learning model for the first one or more structures using the first set of metrology data;
obtaining a second set of metrology data for a second one or more structures; and
performing transfer learning from the first machine learning model to the second set of metrology data to produce a second machine learning model for predicting key parameters for the second one or more structures.

2. The method of claim 1, wherein one of the first one or more structures or the second one or more structures includes larger variations in structural parameters, layer property parameters, material property parameters, or a combination thereof, than an other of the first one or more structures or the second one or more structures.

3. The method of claim 1, wherein the first set of metrology data comprises synthetic metrology data generated from one or more models of the first one or more structures, experimental metrology data generated from the first one or more structures, or a combination thereof and the second set of metrology data comprises synthetic metrology data generated from one or more models of the second one or more structures, experimental metrology data generated from the second one or more structures, or a combination thereof.

4. The method of claim 1, wherein at least a portion of the first set of metrology data is labeled and at least a portion of the second set of metrology data is labeled.

5. The method of claim 1, wherein the first one or more structures and the second one or more structures are different types of structures or are a same type of structures produced using a same or different processes.

6. The method of claim 1, further comprising:
obtaining a third set of metrology data for a third one or more structures;
training a third machine learning model for the third one or more structures using the third set of metrology data; and
performing transfer learning from the third machine learning model with the first machine learning model to the second set of metrology data to produce the second machine learning model for predicting key parameters for the second one or more structures.

7. The method of claim 6, wherein different layers from the first machine learning model and the third machine learning model are transferred to the second machine learning model.

8. The method of claim 1, further comprising:
obtaining a third set of metrology data for a third one or more structures; and
performing transfer learning from the first machine learning model and the second machine learning model to the third set of metrology data to produce a third machine learning model for predicting key parameters for the third one or more structures.

9. The method of claim 8, wherein different layers from the first machine learning model and the second machine learning model are transferred to the third machine learning model.

10. A computer system configured for supporting non-contact measurement of a structure comprising:
at least one processor, wherein the at least one processor is configured to:
obtain a first set of metrology data for a first one or more structures;
train a first machine learning model for the first one or more structures using the first set of metrology data;
obtain a second set of metrology data for a second one or more structures; and
perform transfer learning from the first machine learning model to the second set of metrology data to produce a second machine learning model for predicting key parameters for the second one or more structures.

11. The computer system of claim 10, wherein one of the first one or more structures or the second one or more structures includes larger variations in structural parameters, layer property parameters, material property parameters, or a combination thereof, than an other of the first one or more structures or the second one or more structures.

12. The computer system of claim 10, wherein the first set of metrology data comprises synthetic metrology data generated from one or more models of the first one or more structures, experimental metrology data generated from the first one or more structures, or a combination thereof, and the second set of metrology data comprises synthetic metrology data generated from one or more models of the second one or more structures, experimental metrology data generated from the second one or more structures, or a combination thereof.

13. The computer system of claim 10, wherein at least a portion of the first set of metrology data is labeled and at least a portion of the second set of metrology data is labeled.

14. The computer system of claim 10, wherein the first one or more structures and the second one or more structures are different types of structures or are a same type of structures produced using a same or different processes.

15. The computer system of claim 10, wherein the at least one processor is further configured to:
obtain a third set of metrology data for a third one or more structures;
train a third machine learning model for the third one or more structures using the third set of metrology data; and
perform transfer learning from the third machine learning model with the first machine learning model to the second set of metrology data to produce the second machine learning model for predicting key parameters for the second one or more structures.

16. The computer system of claim 15, wherein different layers from the first machine learning model and the third machine learning model are transferred to the second machine learning model.

17. The computer system of claim 10, wherein the at least one processor is further configured to:
obtain a third set of metrology data for a third one or more structures; and
perform transfer learning from the first machine learning model and the second machine learning model to the third set of metrology data to produce a third machine learning model for predicting key parameters for the third one or more structures.

18. The computer system of claim 17, wherein different layers from the first machine learning model and the second machine learning model are transferred to the third machine learning model.

19. A method for supporting measurement of a structure, the method comprising:
obtaining a first set of metrology data for a first one or more structures;
obtaining a second set of metrology data for a second one or more structures;
selecting metrology data from the first set of metrology data and the second set of metrology data using a feature extractor; and
training a machine learning model with selected metrology data for predicting key parameters for the second one or more structures.

20. The method of claim 19, further comprising minimizing domain differences between the first set of metrology data and the second set of metrology data.

21. The method of claim 20, wherein the domain differences are minimized using a domain classifier via a gradient reversal layer.

22. The method of claim 19, further comprising minimizing domain differences by co-training based on the first set of metrology data and the second set of metrology data.

23. The method of claim 19, wherein the first set of metrology data comprises synthetic metrology data generated from one or more models of the first one or more structures, experimental metrology data generated from the first one or more structures, or a combination thereof, and the second set of metrology data comprises synthetic metrology data generated from one or more models of the second one or more structures, experimental metrology data generated from the second one or more structures, or a combination thereof.

24. The method of claim 19, wherein one set of metrology data comprising either the first set of metrology data or the second set of metrology data is at least partially labeled and a remaining set of metrology data is labeled, unlabeled, or a combination thereof.

25. The method of claim 19, wherein the first one or more structures and the second one or more structures are different types of structures or are a same type of structures produced using a same or different processes.

26. The method of claim 19, further comprising:
obtaining a third set of metrology data for a third one or more structures; and
selecting metrology data from the third set of metrology data with the first set of metrology data and the second set of metrology data using the feature extractor.

27. A computer system configured for supporting non-contact measurement of a sample comprising:
at least one processor, wherein the at least one processor is configured to:
obtain a first set of metrology data for a first one or more structures;
obtain a second set of metrology data for a second one or more structures;
select metrology data from the first set of metrology data and the second set of metrology data using a feature extractor; and
train a machine learning model with selected metrology data for predicting key parameters for the second one or more structures.

28. The computer system of claim 27, wherein the at least one processor is further configured to minimize domain differences between the first set of metrology data and the second set of metrology data.

29. The computer system of claim 28, wherein the domain differences are minimized using a domain classifier via a gradient reversal layer.

30. The computer system of claim 27, wherein the at least one processor is further configured to minimize domain differences by co-training based on the first set of metrology data and the second set of metrology data.

31. The computer system of claim 27, wherein the first set of metrology data comprises synthetic metrology data generated from one or more models of the first one or more structures, experimental metrology data generated from the first one or more structures, or a combination thereof, and the second set of metrology data comprises synthetic metrology data generated from one or more models of the second one or more structures, experimental metrology data generated from the second one or more structures, or a combination thereof.

32. The computer system of claim 27, wherein one set of metrology data comprising either the first set of metrology data or the second set of metrology data is at least partially labeled and a remaining set of metrology data is labeled, unlabeled, or a combination thereof.

33. The computer system of claim 27, wherein the first one or more structures and the second one or more structures are different types of structures or are a same type of structures produced using a same or different processes.

34. The computer system of claim 27, wherein the at least one processor is further configured to:
obtain a third set of metrology data for a third one or more structures; and
select metrology data from the third set of metrology data with the first set of metrology data and the second set of metrology data using the feature extractor.
